(19) United States
(12) Patent Application Publication
(10) Pub. No.: US 2026/0048479 A1
(43) Pub. Date: Feb. 19, 2026

(54) GRINDING WHEEL COOLANT NOZZLE

(71) Applicant: Rolls-Royce Corporation, Indianapolis, IN (US)

(72) Inventors: Gail Plush, Indianapolis, IN (US); Jeremy Russell Ross, Indianapolis, IN (US); John R. Reese, Indianapolis, IN (US); James J. Jackson, Indianapolis, IN (US)

(21) Appl. No.: 18/806,561

(22) Filed: Aug. 15, 2024

(51) Int. Cl. B24B 55/03; B05B 1/14

(52) U.S. Cl. CPC B24B 55/03; B05B 1/14

(57) ABSTRACT

An example coolant nozzle includes a cylindrical shank having a first axial end and a second axial end; a nozzle head extending from the second axial end of the cylindrical shank; a central coolant channel extending from a central axis of the first axial end of the cylindrical shank to partially through a central axis of the nozzle head; and at least one first coolant delivery channel extending radially outward from the central coolant channel to an outer wall of the nozzle head.

### TECHNICAL FIELD

The disclosure relates to the cooling of tools during grinding operations.

### BACKGROUND

During grinding operations on components while using an end surface griding wheel, heat builds up between the workpiece and the abrasive grinding surface, which requires cooling. Traditionally, this cooling is provided by an external coolant injection system, which sprays the coolant on the outer surface of the grinding wheel where it meets the workpiece.

### SUMMARY

The disclosure describes a system for delivering coolant to the inner diameter of a grinding wheel. Due to the high speed rotation of the grinding wheel and the air barrier this imparts around the grinding area, this traditional cooling method may be insufficient and surface burning can occur. Internally cooling the grinding wheel provides superior flow of the coolant and thus results in lower temperatures and enhanced performance of the operation. However, designing specialized consumable grinding wheels is expensive, and being able to modify and use existing systems is desired.

In accordance with one or more aspects of this disclosure, a nozzle is provided to supply coolant to an interior wall of a grinding wheel. The coolant nozzle may include a threaded cylindrical shank configured to allow the nozzle to be attached to the interior of the grinding wheel. The coolant nozzle may also include a nozzle head extending from the end of the shank. A central coolant channel may run axially through the shank and partially through the nozzle head. The nozzle head may further include coolant delivery channels extending radially outward from the central coolant channel. In some examples, the coolant delivery channels may be on an axis perpendicular to the central coolant channel. In other examples, the coolant delivery channels may extend at various angles from an axis perpendicular to the central coolant channel. In this way, coolant fluid may be provided at the interior of various places on a grinding wheel, providing superior cooling at multiple stages of erosion of the grinding wheel.

In some examples, the disclosure describes a system for providing coolant to the interior wall of a grinding wheel. This system may include a coolant tank containing coolant. The system may further include a coolant pump for pumping the coolant from the coolant tank to a milling machine. The milling machine may be a three-axis or five-axis computer controlled machine used for various milling and grinding operations. A grinding wheel assembly may be attached to the machine. The grinding wheel assembly may include a port for receiving coolant through the machine. The grinding wheel assembly may also include a threaded portion on the interior for receiving a coolant nozzle. The coolant nozzle may be configured to receive coolant from the grinding wheel assembly and provide it to the interior wall of the grinding surface of the grinding wheel.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is an exploded view of a grinding wheel assembly.

FIG. 1B is a cutaway view of the grinding wheel assembly of FIG. 1A.

FIG. 2 is a cutaway view of a coolant nozzle.

FIG. 3A is a cutaway view of a grinding wheel assembly in a first eroded state.

FIG. 3B is a cutaway view of a grinding wheel assembly in a second eroded state.

FIG. 4 is a schematic diagram of a machining system.

### DETAILED DESCRIPTION

During grinding operations on components while using an end surface griding wheel, heat builds up between the workpiece and the abrasive grinding surface, which requires cooling. Traditionally, this cooling is provided by an external coolant fluid injection system, which sprays the coolant fluid on the outer surface of the grinding wheel where it meets the workpiece. Due to the high speed rotation of the grinding wheel and the air barrier this imparts around the grinding area, this traditional cooling method is insufficient and surface burning can occur. Internally cooling the grinding wheel provides superior flow of the coolant and thus results in lower temperatures and enhanced performance of the operation.

Some methods of providing coolant to the area where the grinding wheel and workpiece meet require specialized grinding wheels and abrasive pads that allow the coolant fluid to flow through them. This requires expensive consumables which may not be required for all operations. A system of providing coolant fluid through modifications to existing systems provides more flexibility.

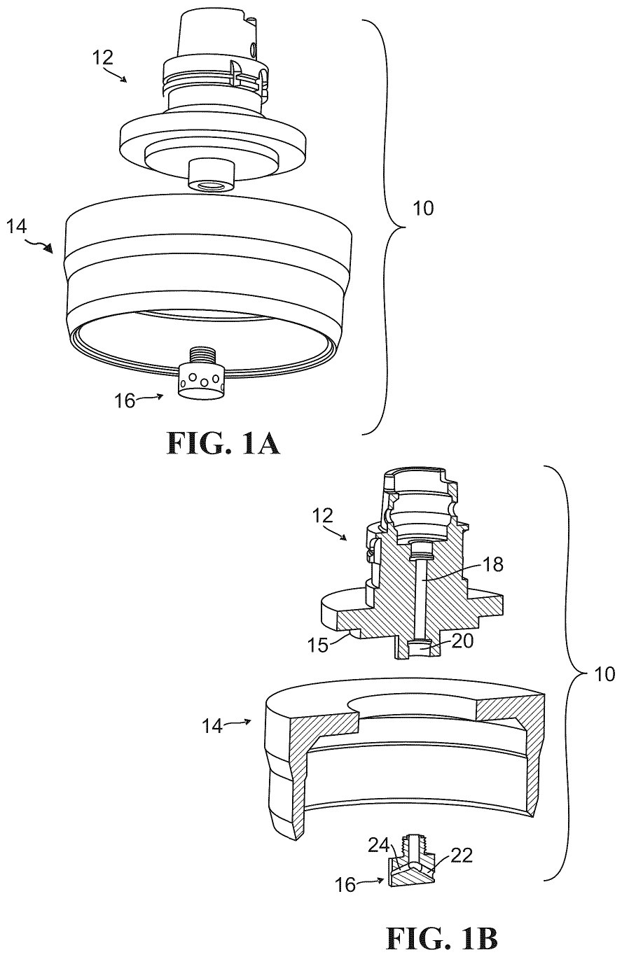

FIG. 1A is an exploded view of a grinding wheel assembly 10. FIG. 1B shows an exploded cutaway view of the grinding wheel assembly 10. As shown in FIGS. 1A and 1B, grinding wheel assembly 10 may include tool holder 12, grinding wheel 14, and coolant nozzle 16.

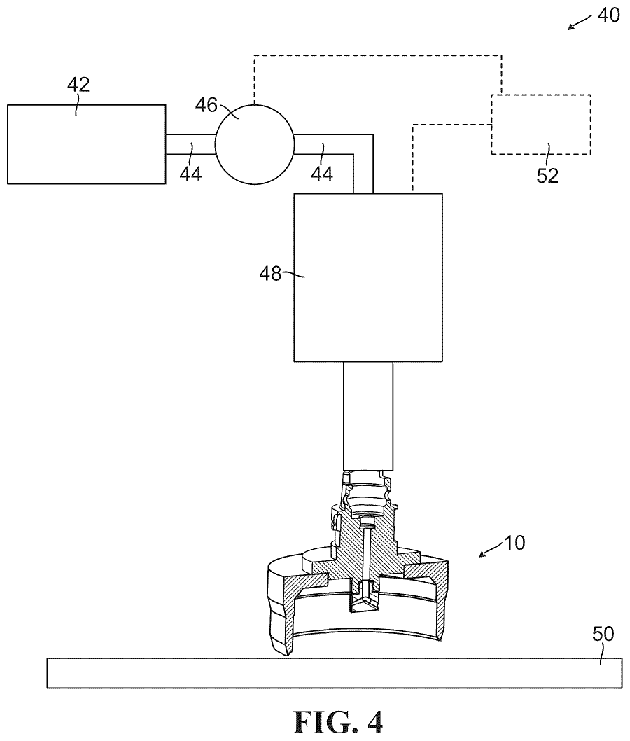

Tool holder 12 may be configured to receive and hold one or more components on a rotating machine, such as a mill (shown in FIG. 4). As shown in the example of FIGS. 1A and 1B, tool holder 12 may hold grinding wheel 14 and coolant nozzle 16. Tool holder 12 may include various features that assist in holding the one or more components. As one example, tool holder 12 may include shoulder 15 that may be configured to mate with grinding wheel 14.

Grinding wheel 14 may be a grinding wheel with an abrasive rim and a hollow center. The grinding wheel 14 may be a cup-type, saucer-type, dish-type, cylinder type, or any other variation of grinding wheel which has a hollow center. As illustrated in FIGS. 1A and 1B, the walls of the grinding wheel 14 may be straight. In other examples, the walls of the grinding wheel may be flared or tapered. Grinding wheel 14 may be attached to tool holder 12 via any suitable mechanism. As one example, grinding wheel assembly 10 may include a cap that sandwiches grinding wheel 14 to tool holder 12.

As noted above, internally cooling a grinding wheel, such as grinding wheel 14, may provide superior flow of the coolant. Such superior flow may result in lower temperatures and/or enhanced performance of the grinding operation.

In accordance with one or more aspects of this disclosure, grinding wheel assembly 10 may provide for internal cooling of grinding wheel 14. For instance, grinding wheel assembly 10 may include coolant nozzle 16 located radially inward of an inner diameter of grinding wheel 14. The coolant nozzle 16 may include one or more coolant delivery channels that direct coolant fluid to grinding wheel 14. Tool holder 12 may include nozzle receiver 20 that may be configured to mate with coolant nozzle 16. For instance, nozzle receiver 20 may include threads for mating with coolant nozzle 16. Coolant nozzle 16 may be threaded to match with the threads of nozzle receiver 20, and such threads may be selected to have a direction that opposes a rotation of grinding wheel assembly (e.g., such that rotation of grinding wheel assembly 10 does not loosen coolant nozzle 16). While described as being attached via threads, other methods of attaching the coolant nozzle 16 to the tool holder 12 may be possible, such as a quick disconnect connection using quick disconnect fittings (e.g., similar to quick disconnect fittings used for hydraulic connections).

Tool holder 12 may be adapted to transport coolant fluid to coolant nozzle 16. For instance, tool holder 12 may include a coolant passage 18 that delivers coolant fluid to coolant nozzle 16. As discussed above, coolant nozzle 16 includes at least one coolant delivery channel, such as first coolant delivery channel 22 that delivers coolant fluid received via coolant passage 18 on to grinding wheel 14. In some examples, coolant nozzle 16 may include multiple coolant channels. For instance, as shown in the example of FIG. 1B, coolant nozzle 16 may include both first coolant delivery channel 22 and at least one second coolant channel 24.

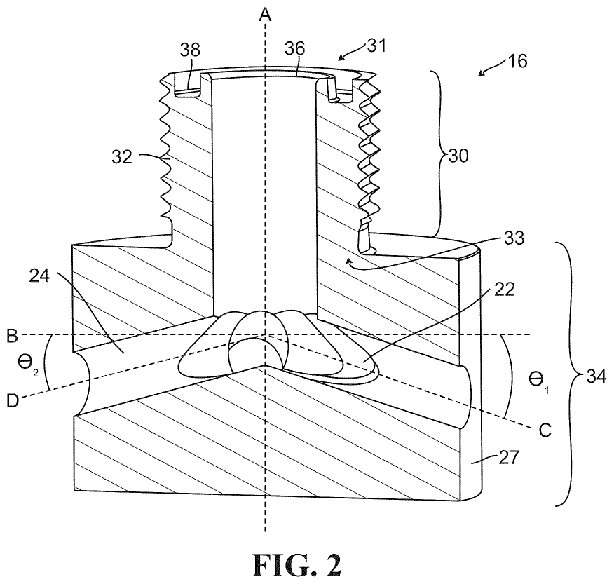

FIG. 2 is a cutaway view of a coolant nozzle 16 which can be attached to a machining system and provide coolant fluid to the interior wall of a grinding wheel. The coolant nozzle 16 includes a cylindrical shank 30 having a first axial end 31 and a second axial end 33. A nozzle head 34 extends axially from the second axial end 33 of the cylindrical shank 30. Threads 32 may be provided on the outer diameter of the cylindrical shank in order to provide means for attaching the coolant nozzle 16 to the nozzle receiver 20 of the tool holder 12.

A central coolant channel 36 extends along a central axis A through the cylindrical shank 30 and partially through the nozzle head 34. The central coolant channel 36 is configured to receive coolant fluid from the coolant passage 18 of the tool holder 12. An o-ring groove 38 may be provided on the first axial end 31 of the cylindrical shank 30 radially outward of the central coolant channel 36 and is configured to prevent any coolant fluid leaks at the interface with the nozzle receiver 20.

The at least one first coolant delivery channel 22 may extend radially outward from the central coolant channel 36 to an outer wall 27 of the nozzle head 34. In some examples, there may be six to fifteen first coolant delivery channels 22. The exact number of first coolant delivery channels 22 and the diameter of those channels will be determined by the pressure of the coolant delivery system and size of the nozzle head 34.

The first coolant delivery channels 22 extend along an axis C, which is at an angle θ₁ from an axis B which is perpendicular to the central axis A and the central coolant channel 36. As one example, the angle θ₁ may be between about 30° and about 45°. As another example, the angle θ₁ may be between about 45° and about 60°. As another example, the angle θ₁ may be between about 5° and about 20°. As another example, the first coolant delivery channels 22 may be perpendicular to the central coolant channel 36, in which case the angle θ₁ would be 0°. The angle θ₁ is determined based on the pressure of the coolant fluid and the distance from the area where the coolant fluid is desired to be delivered. A first angle may be considered “about” a second angle when the first angle is +/−10% of the second angle.

Grinding wheels, such as grinding wheel 14, may be a consumable part. For instance, during use, abrasive material in the grinding wheel 14 may be consumed. Consumption of the abrasive material may reduce a thickness of grinding wheel 14, thereby causing a working surface of grinding wheel 14 to gradually retreat (e.g., retreat along axis A). If the coolant fluid is only provided at one area of the grinding wheel 14, optimal cooling may not be achieved at all states of erosion of the grinding wheel 14. As such, it may be desirable for coolant nozzle 16 to provide coolant fluid at more than one angle.

As discussed above and in accordance with one or more aspects of this disclosure, coolant nozzle 16 may be configured to direct coolant at multiple angles. For instance, coolant delivery channels of coolant nozzle 16 may be formed with multiple different angles, the angles selected to provide coolant to provide coolant to the working surface of a grinding wheel at multiple states of erosion. As shown in FIG. 2, coolant nozzle 16 may include at least one second coolant delivery channel 24 that may extend radially outward from the central coolant channel 36 to an outer wall 27 of the nozzle head 34. In some examples, there may be twelve to fifteen second coolant delivery channels 24. The exact number of second coolant delivery channels 24 and the diameter of those channels will be determined by a variety of factors, including but not limited to the pressure of the coolant fluid in the system and the size of the nozzle head 34.

The second coolant delivery channels 24 may extend along an axis D, which may be at an angle θ₂ from an axis B which may be perpendicular to the central axis A and the central coolant channel 36. As one example, the angle θ₂ may be between about 10° and 20°. As another example, the angle θ₂ may be between about 20° and 30°. As another example, the second coolant delivery channels 24 may be perpendicular to the central coolant channel 36, in which case the angle θ₂ would be 0°. The angle θ₂ may be determined by the pressure of the coolant fluid and the distance from the area where the coolant is desired to be delivered.

As discussed above, the angles of the coolant delivery channels may be selected to provide coolant to the working surface of a grinding wheel at multiple states of erosion. For instance, coolant exiting coolant delivery channel 22 having angle θ₁ may be directed to a working surface of a grinding wheel in a first eroded state. Similarly, coolant exiting coolant delivery channel 24 having angle θ₂ may be directed to the working surface of the grinding wheel in a second eroded state in which the grinding wheel is more eroded than the first eroded state (e.g., when the working surface has retreated up along the A-axis). As such, coolant nozzle 16 may be configured provide coolant to the working surface of a grinding wheel at multiple states of erosion. With coolant provided to the grinding wheel at the multiple states of erosion, the grinding wheel may be more uniformly cooled throughout its life. In this way, operation of a grinding wheel may be improved.

This illustrated as having two sets of coolant delivery channels each having a different angle. For instance, coolant nozzle 16 may include N (e.g., 3, 4, 5, or more) sets of coolant delivery channels having N different angles. As one specific example, coolant nozzle 16 may include at least one third coolant delivery channel at an angle θ₃ from an axis B, angle θ₃ may be less than angle θ₂.

A diameter of the coolant delivery channels may be selected based on various parameters. As one example, a diameter of the first coolant delivery channels 22 may be selected based on the angle θ₁. As another example, a diameter of the second coolant delivery channels 24 may be selected based on the angle θ₂. As one specific example, the diameter of the first coolant delivery channels may be 0.25″ and the diameter of the second coolant delivery channels may be 0.125″.

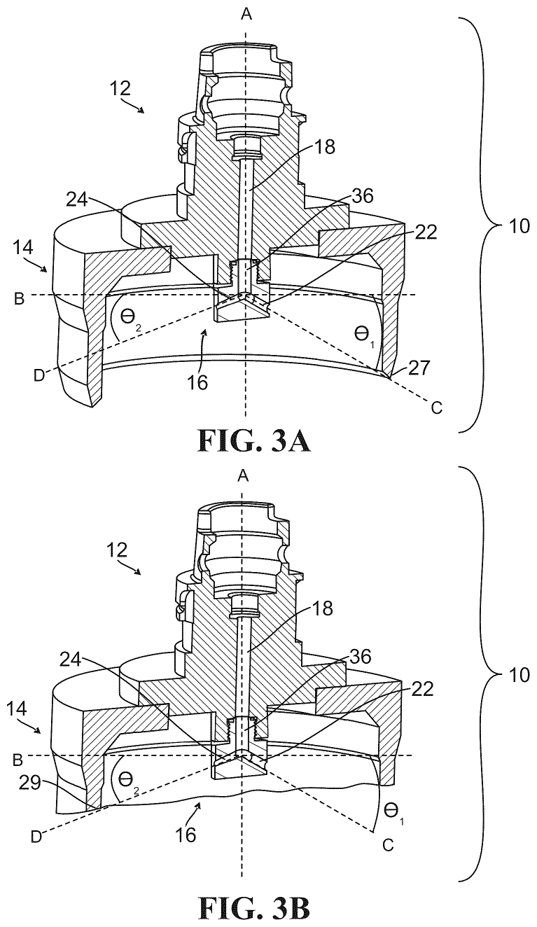

FIGS. 3A and 3B are cutaway views of the grinding wheel assembly 10. Coolant fluid passes through the coolant passage 18 of the tool holder 12, through the central coolant channel 36 and into the first coolant delivery channels 22 and the second coolant delivery channels 24.

FIG. 3A shows the grinding wheel 14 in its first eroded state. The first eroded state of the grinding wheel 14 may be a state in which the grinding wheel is uneroded, or very nearly uneroded. In the first eroded state, the angle θ₁ may be such that the intersection 37 of axis C through the first coolant delivery channels 22 and the grinding wheel 14 is near the working surface of the grinding wheel 14. The working surface of the grinding wheel is defined as the exposed end of the grinding wheel 14 which is performing the grinding. Providing the coolant fluid at or near the working surface of the grinding wheel 14 may provide more optimal cooling.

FIG. 3B shows the grinding wheel 14 in its second eroded state. Grinding wheel 14 may reach the second eroded state after grinding wheel 14 is used following being at the first eroded state. The second eroded state may be when the grinding wheel is about 50% eroded. In other examples, the second eroded state may be when the grinding wheel is about 75% eroded. The angle θ₂ may be such that the intersection 39 of axis D through the second coolant delivery channels 24 and the grinding wheel 14 is near the working surface of the grinding wheel 14 when it is in its second eroded state. The angle θ₂ may be less than the angle θ₁. The second eroded state, and thus the angle θ₂, may be selected in order to optimize cooling when the cooling fluid is provided along the entire useful area of the grinding wheel by both the first coolant delivery channels 22 and the second coolant delivery channels 24.

One of ordinary skill in the art would understand that in other examples, additional coolant delivery channels and other angles could be provided in order to further optimize cooling at additional states of erosion of the grinding wheel 14.

FIG. 4 shows the grinding wheel assembly 10 as part of a machining system 40. Coolant fluid may be stored in coolant tank 42. When operating, coolant pump 46 may be configured to pump coolant fluid out of the coolant tank 42, through the pipes 44 and into the milling machine 48. Coolant fluid may pass through the milling machine 48 and into the grinding wheel assembly 10. As the grinding wheel assembly 10 works on the part 50, the coolant may be provided at the appropriate intersection of grinding wheel 14 and part 50.

The coolant fluid stored in coolant tank 42 may be of any type appropriate to provide appropriate cooling and lubrication of grinding wheel 14. The coolant fluid may also be used to lubricate parts of milling machine 48.

The coolant pump 46 may be a centrifugal pump. In other applications, the coolant pump 46 may be a gear pump, a vane pump, or other type of pump appropriate to pump coolant fluid at the desired flow rates and pressures needed for the application.

The milling machine 48 may be multi-axis (e.g., a 3-axis, 4-axis, or 5-axis milling machine). If the milling machine 48 is computer controlled, for example a computer numerical control (CNC) machine, a controller 52 may be included in the machining system 40. The controller 52 may control the operation of the milling machine 48 as well as the coolant pump 46.

The part 50 may be any part which is worked upon by the grinding wheel assembly 10. In some applications it may be a metal or metal alloy part. In other applications the part 50 may be a carbon-fiber or other composite material.

The following enumerated clauses describe various examples according to the present disclosure.

Clause 1. A coolant nozzle, comprising: a cylindrical shank having a first axial end and a second axial end; a nozzle head extending from the second axial end of the cylindrical shank; a central coolant channel extending from a central axis of the first axial end of the cylindrical shank to partially through a central axis of the nozzle head; and at least one first coolant delivery channel extending radially outward from the central coolant channel to an outer wall of the nozzle head.

Clause 2. The coolant nozzle of clause 1, wherein the at least one first coolant delivery channel is perpendicular to the central coolant channel.

Clause 3. The coolant nozzle of clause 1, wherein the at least one first coolant delivery channel is at a first non-zero angle relative to an axis perpendicular to the central coolant channel.

Clause 4. The coolant nozzle of clause 3, wherein the first angle causes coolant exiting the at least one first coolant delivery channel to be directed to a working surface of a grinding wheel in a first eroded state.

Clause 5. The coolant nozzle of clause 4, wherein the first angle is between about 45° and about 60°.

Clause 6. The coolant nozzle of clause 4 or clause 5, further comprising at least one second coolant delivery channel, the second coolant delivery channel at a second angle relative to the axis perpendicular to the central coolant channel, and wherein the second angle is less than the first angle.

Clause 7. The coolant nozzle of clause 6, wherein the second angle causes coolant exiting the at least one second coolant delivery channel to be directed to a working surface of the grinding wheel in a second eroded state in which the grinding wheel is more eroded than the first eroded state.

Clause 8. The coolant nozzle of clause 7, wherein the second angle is between about 20° and about 40°.

Clause 9. The coolant nozzle of any of clauses 1-8, wherein the cylindrical shank further includes an o-ring set into the first axial end.

Clause 10. The coolant nozzle of any of clauses 1-9, wherein the cylindrical shank is threaded on an outer diameter.

Clause 11. A system comprising: a coolant tank containing a coolant fluid; a milling machine; a coolant pump configured to pump the coolant fluid from the coolant tank to the milling machine; a controller configured to control the milling machine; a grinding wheel attached to the milling machine; and a coolant nozzle attached to the milling machine radially inward of an inner diameter of the grinding wheel, the coolant nozzle comprising: a cylindrical shank having a first axial end and a second axial end; a nozzle head extending from the second axial end of the cylindrical shank; a central coolant channel extending from a central axis of the first axial end of the cylindrical shank to partially through a central axis of the nozzle head; and at least one first coolant delivery channel extending radially outward from the central coolant channel to an outer wall of the nozzle head.

Clause 12. The system of clause 11, wherein the at least one first coolant delivery channel delivers the coolant from the coolant tank to an intersection of an interior wall of the grinding wheel and a working surface of the grinding wheel in a first eroded state.

Clause 13. The system of clause 11, wherein the coolant nozzle further comprises at least one second coolant delivery channel extending radially outward from the central coolant channel to an outer wall of the nozzle head.

Clause 14. The system of clause 13, wherein the at least one second coolant delivery channel delivers the coolant from the coolant tank to an intersection of an interior wall of the grinding wheel and a working surface of the grinding wheel in a second eroded state.

Clause 15. The system of any of clauses 11-14, wherein the controller is further configured to control the coolant pump.

Clause 16. The system of any of clauses 11-15, wherein the milling machine is a 3-axis milling machine.

Clause 17. The system of any of clauses 11-16, wherein the milling machine is a 5-axis milling machine.

Clause 18. The system of clauses 11-17, wherein the coolant nozzle further includes threads on an outer diameter of the cylindrical shank and wherein the coolant nozzle is attached to the milling machine with a threaded connection.

Clause 19. The system of any of clauses 11-18, wherein the coolant nozzle is attached to the milling machine with a quick-disconnect connection.

Clause 20. The system of any of clauses 11-19, wherein the grinding wheel is a cup-type grinding wheel.

Various examples have been described. These and other examples are within the scope of the following claims.

What is claimed is:

1. A coolant nozzle, comprising:
a cylindrical shank having a first axial end and a second axial end;
a nozzle head extending from the second axial end of the cylindrical shank;
a central coolant channel extending from a central axis of the first axial end of the cylindrical shank to partially through a central axis of the nozzle head; and
at least one first coolant delivery channel extending radially outward from the central coolant channel to an outer wall of the nozzle head.

2. The coolant nozzle of claim 1, wherein the at least one first coolant delivery channel is perpendicular to the central coolant channel.

3. The coolant nozzle of claim 1, wherein the at least one first coolant delivery channel is at a first angle relative to an axis perpendicular to the central coolant channel.

4. The coolant nozzle of claim 3, wherein the first angle causes coolant exiting the at least one first coolant delivery channel to be directed to a working surface of a grinding wheel in a first eroded state.

5. The coolant nozzle of claim 4, wherein the first angle is between about 45° and about 60°.

6. The coolant nozzle of claim 4, further comprising at least one second coolant delivery channel, the second coolant delivery channel at a second angle relative to the axis perpendicular to the central coolant channel, and wherein the second angle is less than the first angle.

7. The coolant nozzle of claim 6, wherein the second angle causes coolant exiting the at least one second coolant delivery channel to be directed to a working surface of the grinding wheel in a second eroded state in which the grinding wheel is more eroded than the first eroded state.

8. The coolant nozzle of claim 7, wherein the second angle is between about 20° and about 40°.

9. The coolant nozzle of claim 1, wherein the cylindrical shank further includes an o-ring set into the first axial end.

10. The coolant nozzle of claim 1, wherein the cylindrical shank is threaded on an outer diameter.

11. A system comprising:
a coolant tank containing a coolant fluid;
a milling machine;
a coolant pump configured to pump the coolant fluid from the coolant tank to the milling machine;
a controller configured to control the milling machine;
a grinding wheel attached to the milling machine; and
a coolant nozzle attached to the milling machine radially inward of an inner diameter of the grinding wheel, the coolant nozzle comprising:
a cylindrical shank having a first axial end and a second axial end;
a nozzle head extending from the second axial end of the cylindrical shank;
a central coolant channel extending from a central axis of the first axial end of the cylindrical shank to partially through a central axis of the nozzle head; and
at least one first coolant delivery channel extending radially outward from the central coolant channel to an outer wall of the nozzle head.

12. The system of claim 11, wherein the at least one first coolant delivery channel delivers the coolant from the coolant tank to an intersection of an interior wall of the grinding wheel and a working surface of the grinding wheel in a first eroded state.

13. The system of claim 11, wherein the coolant nozzle further comprises at least one second coolant delivery channel extending radially outward from the central coolant channel to an outer wall of the nozzle head.

14. The system of claim 13, wherein the at least one second coolant delivery channel delivers the coolant from the coolant tank to an intersection of an interior wall of the grinding wheel and a working surface of the grinding wheel in a second eroded state.

15. The system of claim 11, wherein the controller is further configured to control the coolant pump.

16. The system of claim 11, wherein the milling machine is a 3-axis milling machine.

17. The system of claim 11, wherein the milling machine is a 5-axis milling machine.

18. The system of claim 11, wherein the coolant nozzle further includes threads on an outer diameter of the cylindrical shank and wherein the coolant nozzle is attached to the milling machine with a threaded connection.

19. The system of claim 11, wherein the coolant nozzle is attached to the milling machine with a quick-disconnect connection.

20. The system of claim 11, wherein the grinding wheel is a cup-type grinding wheel.
